(19) United States
(12) Patent Application Publication
(10) Pub. No.: US 2022/0414348 A1
(43) Pub. Date: Dec. 29, 2022

(54) CONTEXT-AWARE CONVERSATION COMPREHENSION EQUIVALENCY ANALYSIS AND REAL TIME TEXT ENRICHMENT FEEDBACK FOR ENTERPRISE COLLABORATION

(71) Applicant: Cisco Technology, Inc., San Jose, CA (US)

(72) Inventors: Goudam Jaganmohan Muralitharan, San Jose, CA (US); Gonzalo SALGUEIRO, Raleigh, NC (US); Julie ALLEN, Sioux Falls, SD (US); Pascale DELAUNAY, La Verne, CA (US); Rekha GOPIKRISHNAN, Redmond, WA (US); Derek ENGI, Ferndale, MI (US)

(21) Appl. No.: 17/357,545

(22) Filed: Jun. 24, 2021

(51) Int. Cl. G06F 40/44; G06F 16/335; G10L 15/26; G06N 20/00

(52) U.S. Cl. CPC G06F 40/44; G06F 16/335; G10L 15/26; G06N 20/00

(57) ABSTRACT

In one embodiment, a device determines a comprehension level for a portion of text associated with an online conversation, based in part on a topic of the portion of text. The device makes a comparison between the comprehension level for the portion of text with a comprehension level of a participant of the online conversation. The device generates adjusted text based on the portion of text, wherein the adjusted text has a comprehension level that is equal to or lower than that of the participant. The device provides the adjusted text for display to the participant.

### TECHNICAL FIELD

The present disclosure relates generally to computer networks, and, more particularly, to context-aware conversation comprehension equivalency analysis and real time text enrichment feedback for enterprise collaboration.

### BACKGROUND

Schools, businesses, and other entities are increasingly using online collaboration tools to facilitate communications between users. These collaboration tools range from text-based applications, such as instant messaging applications, Short Message Service (SMS) messaging, etc., to audio and/or video-based applications, such as video conferencing, and the like.

Oftentimes, the users of collaboration tools bring their own levels of expertise that result in fundamental differences in how each and every individual understands what is being conveyed. Reading fluency is one such example of this deviation in language competency across users. This leads to a gap in understanding between users, which is exacerbated with the increase in remote collaborations.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for adjusting text during a collaboration session;

FIG. 4 illustrates an example architecture for a smart text reading level adjustment (STERLA) engine;

FIG. 5 illustrates an example of the adjustment of text during a text-based conversation;

FIG. 6 illustrates an example of providing adjusted text in conjunction with a video conference; and

FIG. 7 illustrates an example simplified procedure for providing adjusted text for display to a participant of an online conversation.

### DESCRIPTION OF EXAMPLE EMBODIMENTS

### Overview

According to one or more embodiments of the disclosure, a device determines a comprehension level for a portion of text associated with an online conversation, based in part on a topic of the portion of text. The device makes a comparison between the comprehension level for the portion of text with a comprehension level of a participant of the online conversation. The device generates adjusted text based on the portion of text, wherein the adjusted text has a comprehension level that is equal to or lower than that of the participant. The device provides the adjusted text for display to the participant.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

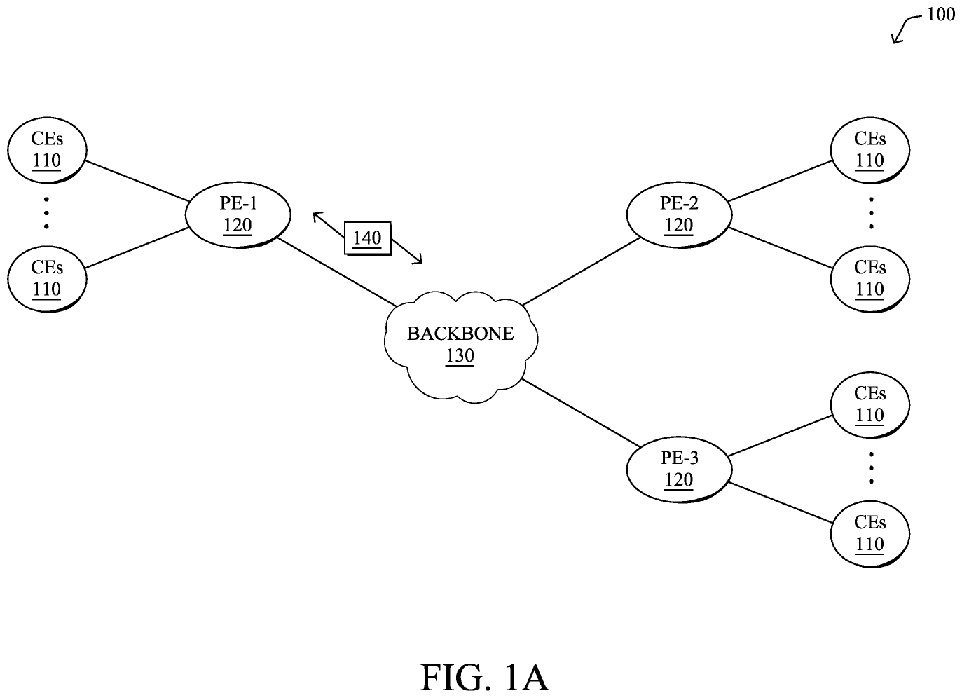

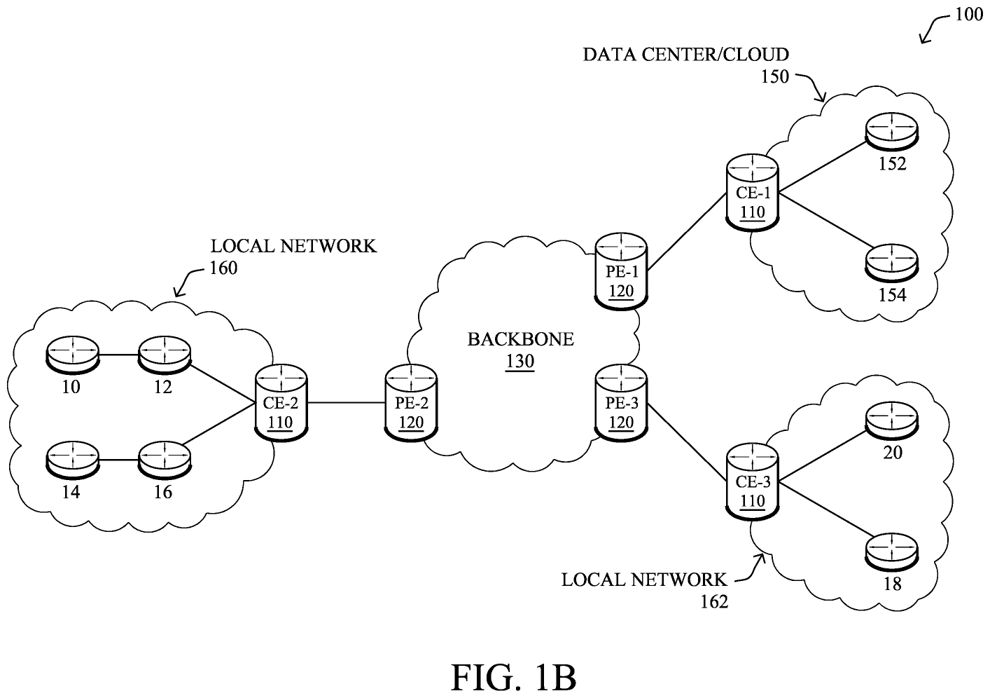

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types: 2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

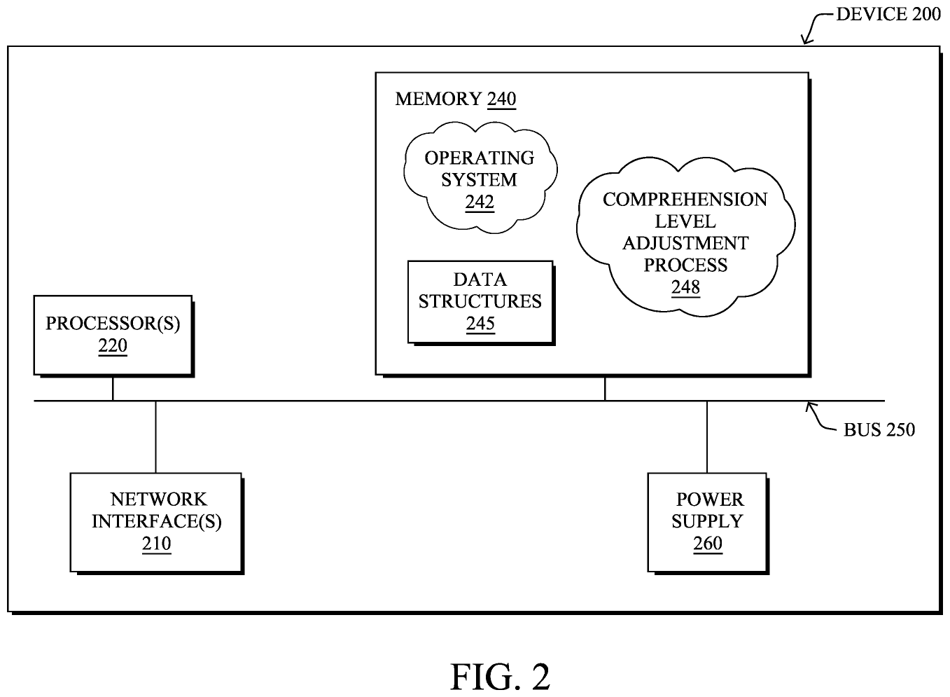

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a comprehension level adjustment process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, comprehension level adjustment process 248 may also include computer executable instructions that, when executed by processor(s) 220, cause device 200 to perform the techniques described herein. To do so, in some embodiments, comprehension level adjustment process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, comprehension level adjustment process 248 may employ one or more supervised, unsupervised, or semi-supervised machine learning models. Generally, supervised learning entails the use of a training set of data, as noted above, that is used to train the model to apply labels to the input data. For example, the training data may include sample text that has been labeled as being related to a particular topic. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the data. Semi-supervised learning models take a middle ground approach that uses a greatly reduced set of labeled training data.

Example machine learning techniques that comprehension level adjustment process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

As noted above, an increasing number of schools, businesses, and other entities are increasingly using online collaboration tools to facilitate communications between users. These collaboration tools range from text-based applications, such as instant messaging applications, Short Message Service (SMS) messaging, etc., to audio and/or video-based applications, such as video conferencing, and the like.

Oftentimes, the users of collaboration tools bring their own levels of expertise that result in fundamental differences in how each and every individual understands what is being conveyed. Reading fluency is one such example of this deviation in language competency across users. This leads to a gap in understanding between users, which is exacerbated with the increase in remote collaborations.

Context-Aware Conversation Comprehension Equivalency and Real Time Enrichment Feedback for Enterprise Collaboration

The techniques introduced herein help to bridge the gap between text for presentation to a user and the reading comprehension level of that user. In various aspects, a multi-layered system is introduced herein that assesses the comprehension level of source material (text/audio transcripts), learns and establishes the comprehension level of the recipient, analyzes comprehension equality at the topic and keyword level, and/or adaptively transforms source material to the required comprehension of the target recipient.

Illustratively, the techniques described herein may be performed by hardware, software, and/or firmware, such as in accordance with comprehension level adjustment process 248, which may include computer executable instructions executed by the processor 220 (or independent processor of interfaces 210) to perform functions relating to the techniques described herein.

Specifically, according to various embodiments, a device determines a comprehension level for a portion of text associated with an online conversation, based in part on a topic of the portion of text. The device makes a comparison between the comprehension level for the portion of text with a comprehension level of a participant of the online conversation. The device generates adjusted text based on the portion of text, wherein the adjusted text has a comprehension level that is equal to or lower than that of the participant. The device provides the adjusted text for display to the participant.

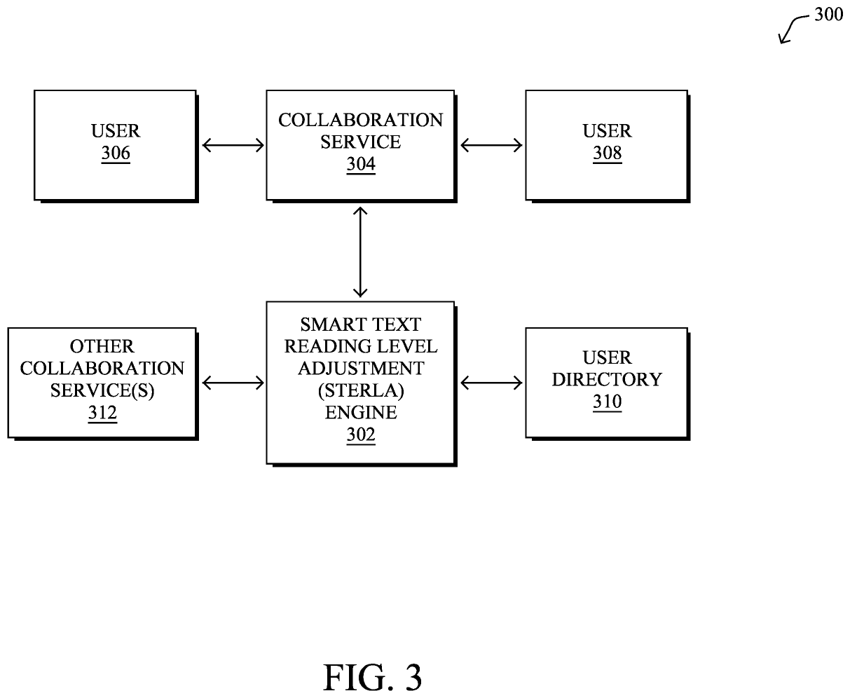

Operationally, FIG. 3 illustrates an example architecture 300 for a smart text reading level adjustment (STERLA) engine 302, according to various embodiments. In general, engine 302 may operate in conjunction with a collaboration service 304, either as an integrated function or executed in a distributed manner. Collaboration service 304 may include any or all of the following:
A videoconferencing application—such an application may allow two or more users to exchange video and/or audio data.
A voice-only application—such an application may allow two or more users to exchange audio data, similar to a videoconferencing application, but lacks support for the exchange of video data.
A text-based messaging application—such an application may allow two or more users to exchange text data, such as in real time (e.g., instant messaging, SMS, etc.), via email, or the like.

As would be appreciated, a conversation between two or more users of collaboration service 304 may be unidirectional, bidirectional, or multi-directional, in various cases. For instance, certain conversations may be unidirectional in which only one user actually contributes to the conversation, while one or more other participants simply acts as a consumer (e.g., a reader, a listener, a viewer, etc.). Other conversations via collaboration service 304 may be more collaborative in nature, whereby two or more users actually provide text, audio, and/or video to the conversation.

For instance, a first user 306 may participate in a conversation with a second user 308 via collaboration service 304. Thus, user 306 may provide text, audio, and/or video to user 308 via collaboration service 304 during a given conversation. Conversely, user 308 may provide text, audio, and/or video to user 306 via collaboration service 304 as part of that conversation, as well.

According to various embodiments, as detailed further below, STERLA engine 302 may be operable to ‘translate’ the text, audio, video or other content provided by one participant of an online conversation such that it is at, or below, that of the comprehension level of another participant. Consider, for instance, user 306 sending a text message to user 308 via collaboration service 304. This text may range from being very simplistic to using phrases or terminology that is highly specialized. As a result, there are instances in which user 308 may not fully understand what user 306 is saying. A key functionality of STERLA engine 302 is to assess this text and adjust it for presentation to user 308, to increase the potential for user 308 to comprehend the message.

To assist the operation of STERLA engine 302, STERLA engine 302 may also operate in conjunction with one or more other collaboration services 312, a user directory 310, and/or any other additional sources. Generally, these sources serve to provide STERLA engine 302 information indicative of the comprehension level of a given user. For instance, in some embodiments, collaboration service(s) 312 and/or collaboration service 304 may provide transcripts of prior conversations involving a particular user, allowing STERLA engine 302 to infer the comprehension level of that user from their previous contributions to any number of different conversations. In further cases, STERLA engine 302 may infer the comprehension level of a particular user based on their user profile information in user directory 310, which may indicate their education level, type of education or work experience, role within an organization, or the like.

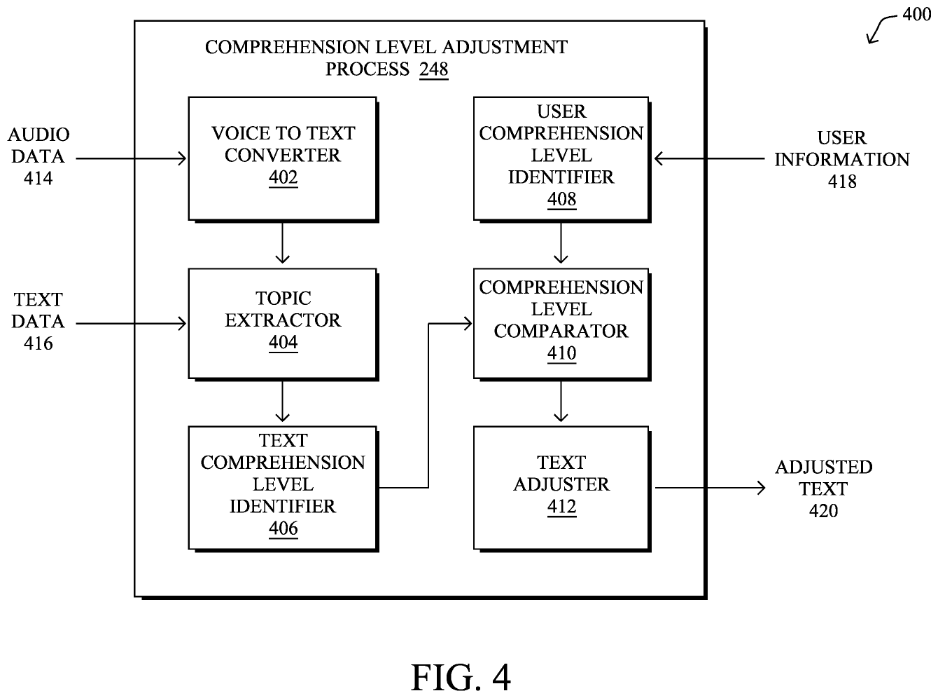

FIG. 4 illustrates an example architecture 400 for a STERLA engine, such as STERLA engine 302, according to various embodiments. At the core of architecture 400 is comprehension level adjustment process 248, which may be executed by a device that provides a collaboration service in a network, or another device in communication therewith. As shown, comprehension level adjustment process 248 may include any or all of the following components: a voice-to-text converter 402, a topic extractor 404, a text comprehension level identifier 406, a user comprehension level identifier 408, a comprehension level comparator 410, and/or a text adjuster 412. As would be appreciated, the functionalities of these components may be combined or omitted, as desired. In addition, these components may be implemented on a singular device or in a distributed manner, in which case the combination of executing devices can be viewed as their own singular device for purposes of executing comprehension level adjustment process 248.

According to various embodiments, architecture 400 can be used to implement a multi-layered system summarized by any or all of the following functionalities:
Assessment of the comprehension level of source material (text/audio transcripts)
Learning and establishing the comprehension level of the recipient
Comprehension equality analysis at the topic and keyword level
Dynamic translation of source material to the required comprehension of the target recipient

A first operation of comprehension level adjustment process 248 may be to obtain a textual representation of an online conversation, which may be ongoing or already conducted (e.g., a transcript, etc.). In cases in which the conversation is text-based, this may entail comprehension level adjustment process 248 receiving text data 416 which may include the original text sent by a participant. In addition, in some embodiments, text data 416 may also include metadata regarding the text, such as the identity of the sender, the identity of any recipient, etc.). For instance, an example data structure for text data 416 is as follows:

```
{
  “originalText”: “<text>”;
  “sender”: “<sender>”,
  “recipients”: [“<recipient_1>”, “<recipient_2>”,..., “<recipient_n>”]
}
```

In some cases, the online conversation may be non-textual, such as when a participant provides spoken audio, video, or the like. Accordingly, in some embodiments, comprehension level adjustment process 248 may use voice-to-text converter 402 to convert audio data 414 into a textual representation of the spoken audio. In further embodiments, comprehension level adjustment process 248 may also convert images and/or video into text, such as by using optical character recognition, convolutional neural network (CNN)-based image recognition, or the like. Regardless, the resulting text may be used as input to topic extractor 404, similar to text data 416. Note also that any converted text may also include any or all of the metadata of text data 416, such as the identities of the sender and/or recipient(s).

In various embodiments, topic extractor 404 may assess text data 416 or text from voice-to-text converter 402 (or any other text converter), to identify the topic(s) present in a particular portion of text. For instance, topic extractor 404 may assess a singular message, a sentence, a paragraph, or a portion thereof, to identify any keywords associated with a particular topic. In some instances, topic extractor 404 may compute the term frequency-inverse document frequency (TF-IDF) or other measure of the importance of the various words present in the portion of text, to determine the topics(s) present in that that portion of text.

According to various embodiments, text comprehension level identifier 406 may assess the text of the conversation, as well as any potential topics extracted by topic extractor 404, to assign a text comprehension level to any portion of the text. In some embodiments, comprehension levels can be calculated using comprehension tests that often require a human person to complete assessments such as filling the blanks in a sentence by selecting the best word. Readability tests can be used used as an alternative to evaluate the readability of texts by counting characters, words, sentences, syllables, complex words, average syllables per word, and related metrics. For instance, text comprehension level identifier 406 may compute any or all of the following for a portion of text: a Flesch-Kincaid grade level, a Coleman-Liau index, a Dale-Chall readability formula, a Gunning fog index, or the like.

Note that each test/formula that text comprehension level identifier 406 may use has its own set of pros and cons. For example, some are best suited for shorter/lesser sentences and some are suited for longer/more sentences. It is best advised to use a combination of these scores to attain an accurate assessment of the reading level of text. In some embodiments, text comprehension level identifier 406 may adaptively select a combination of readability tests or formulas that are best suited for the portion of text under analysis. In further embodiments, the comprehension level scoring for the text may also be topic-specific. For instance, if the portion of text relates to electrical engineering, it may have a low comprehension level for users that have no particular expertise in electrical engineering, but a relatively high comprehension level for those whose, jobs involve electrical engineering.

According to various embodiments, user comprehension level identifier 408 may determine the comprehension level of a particular user/conversation participant, based on user information 418. Generally speaking, user information 418 may indicate any or all of the following information:
Prior reading comprehension score(s), if already available

Prior text, audio, and/or video provided by the user, from which a reading score can be computed
Demographics (e.g., age group, education, etc.)
Location
Business group or role
Technical expertise
Culture
Etc.

The underlying logic for user comprehension level identifier 408 may be somewhat similar to how text comprehension level identifier 406 computes the comprehension levels for different portions of text. Here, user comprehension level identifier 408 may infer the comprehension level of a particular participant from their demographics or other directory information and/or by learning their comprehension level over time. In other words, user comprehension level identifier 408 may analyze the textual representation of the participants' own words, to score their comprehension level. Note that in some embodiments, this scoring can also be on a per-topic basis.

In one embodiment, user comprehension level identifier 408 may recompute the comprehension level for a user/participant over the course of time. For instance, user comprehension level identifier 408 may compute a running average of the reading scores of all text written by the user over time (avg.rs) and the reading score of the new text (rsₙ) as follows:

$$avg . r s = \frac{r {s}_{n - 1} * ( n - 1 ) + {rs}_{n}}{n}$$

where n is the total number of times the score was calculated.

According to various embodiments, comprehension level comparator 410 may assess the portion of text, its associated comprehension level(s), and the comprehension level(s) of a conversation participant, to determine whether the comprehension level of the participant meets or exceeds that required for the portion of text. In some embodiments, this comparison may also be done on a per-topic basis and/or generally across all topics. Doing so allows comprehension level comparator 410 to consider instances in which the participant has specialized knowledge about a particular topic of conversation.

In various embodiments, text adjuster 412 may generate adjusted text for a portion of text, based on the comprehension level assessment by comprehension level comparator 410. In some embodiments, this may be done on a user-configurable basis, thereby allowing the receiving participant to opt into the text adjustment capabilities of the STERLA engine. For instance, the participant or an administrator may be able to set one or more parameters that control whether the STERLA engine adjusts any conversation text, to ensure that the comprehension level of the participant meets or exceeds that of the adjusted text.

More specifically, when the comprehension level of a participant is lower than that of the portion of text under analysis, text adjuster 412 may perform any or all of the following adjustments to the text:
Replace idioms/complex phrases with explanations appropriate for the comprehension level of the participant
Replace complex words with words appropriate for the comprehension level of the participant.
Break down complex and lengthier sentences into simpler and shorter sentences

Indeed, in many corporate and academic settings, there are multiple verticals and functional teams, each having their own jargon, acronyms, and terminologies that are nigh incomprehensible to an outsider. Any large-scale organization usually has many cross-functional teams geographically distributed and collaborating remotely over diverse projects. Such cross-pollinations combined with comprehension level deltas further bring down the engagement experience between groups. Here, text adjuster 412 may mitigate this issue by performing transformations on domain-specific knowledge in the original text. More specifically, text adjuster 412 may maintain an ever-growing dictionary of abbreviations, acronyms, names, words, and/or phrases that are specific to a particular domain, geographic location, business groups, enterprise, industry, or the like. This helps text adjuster 412 to provide context-aware and adaptive transformation.

A sample enrichment of a portion of text by text adjuster 412 may involve any or all of the following:

1. Identify the sender and recipient's demographics-business groups, age groups, location, and other distinguishing factors.

2. Depending on the degree of differences in their demographics, replace acronyms, abbreviations, and jargon with words appropriate for the recipient's reading score and demographic.

Once text adjuster 412 has generated the adjusted text 420, it may provide adjusted text 420 for presentation to the participant. An example data structure to do so may be as follows:

```
{
  “originalText”: “<text>”;
  “sender”: “<sender>”,
  “recipients”: [“<recipient_1>”, “<recipient_2>”,..., “<recipient_n>”]
  “adaptedText”: [“transformed_enriched_text_ 1>”, “<original_text_2>”,...,
    “<transformed_text_n>”]
}
```

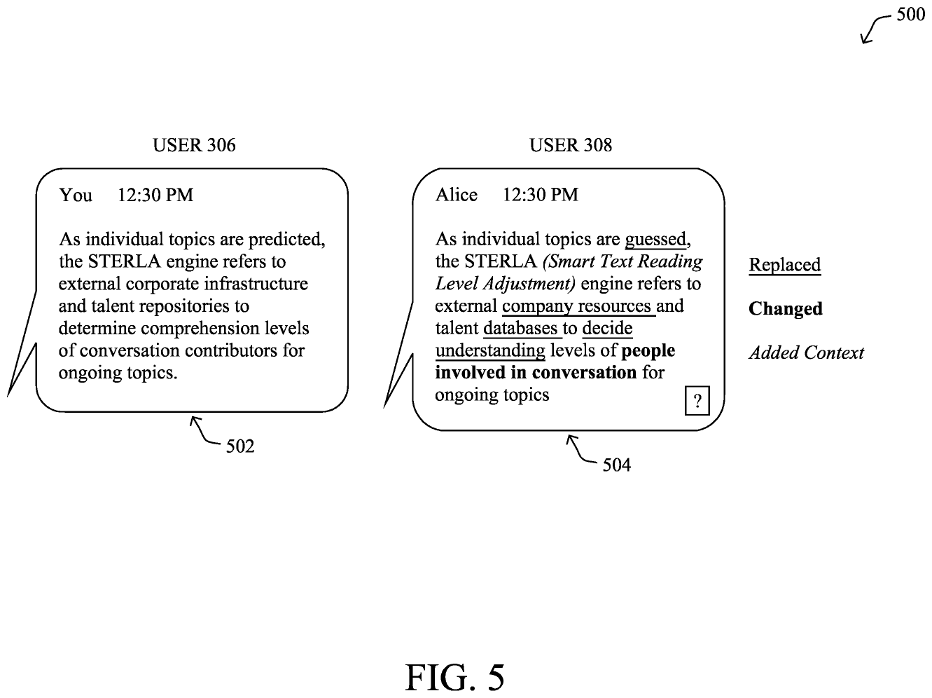

Thus, some participants may be presented with adjusted text, while other participants may simply be presented with the original portion of text, depending on their respective comprehension levels relative to that portion of text. FIG. 5 illustrates an example 500 of such an adjustment of text during a text-based conversation, according to various embodiments. As shown, assume that user 306 has a much higher comprehension level than that of user 308 and that both users are recipients of text during an online conversation. In the case of user 306, that participant may be presented with the original text 502 from the sender, since their comprehension level exceeds that of the text.

However, in the case of user 308, that user may instead be presented with adjusted text 504 that comprises various adjustments of the original text 502. For instance, if user 308 is unfamiliar with the “STERLA” acronym, adjusted text 504 may include additional context, so that user 308 understands the context of the conversation. Similarly, certain terms in the original text 502 may also be replaced or changed, thereby allowing user 308 to better understand the conversation.

In some embodiments, as shown, adjusted text 504 may also include an indication of any words or symbols that have been added, changed, or replaced in adjusted text 504 from that of the original text 502. For instance, this indication may include different fonts, text formats (e.g., underlines, bold text, italicized text, etc.), colorations or other graphical indicia, or the like, to signify any deltas between adjusted text 504 and original text 502.

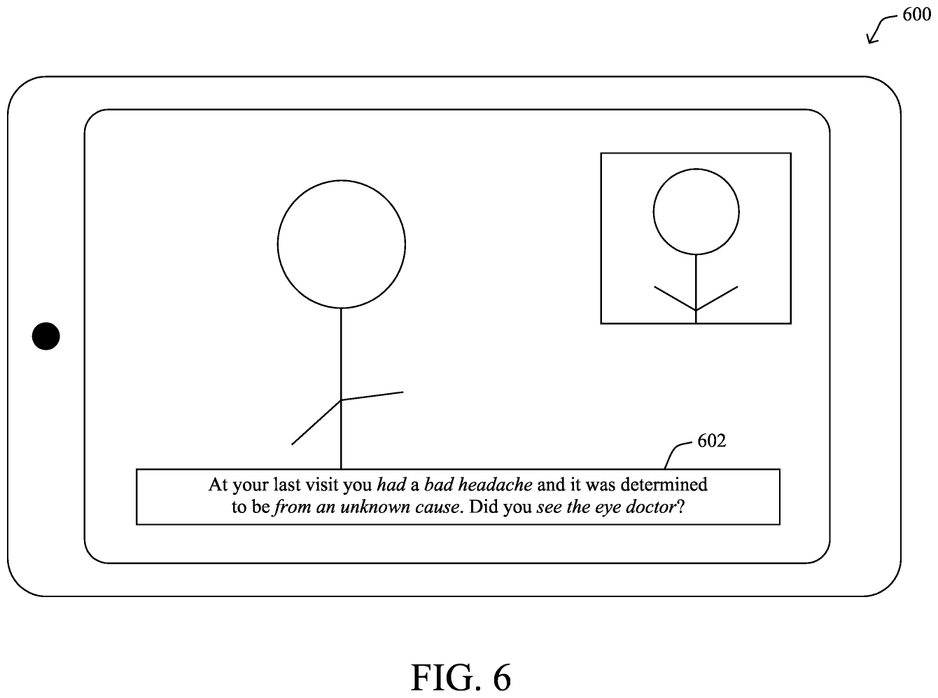

FIG. 6 illustrates another example 600 of providing adjusted text, this time in conjunction with a video conference, according to further embodiments. Here, as noted above, the conversation may be conveyed visually (e.g., using sign language) or auditorily via video and/or audio data. Here, the underlying STERLA engine may convert any such audio or video into text, before then applying its comprehension level analysis and text adjustment capabilities. In turn, the STERLA engine may present the adjusted text in conjunction with the video conference (e.g., as subtitles, side text, etc.). This allows the participant to quickly grasp what is being said in the conversation, even if the original spoken or visual words were at a comprehension level above that of the participant.

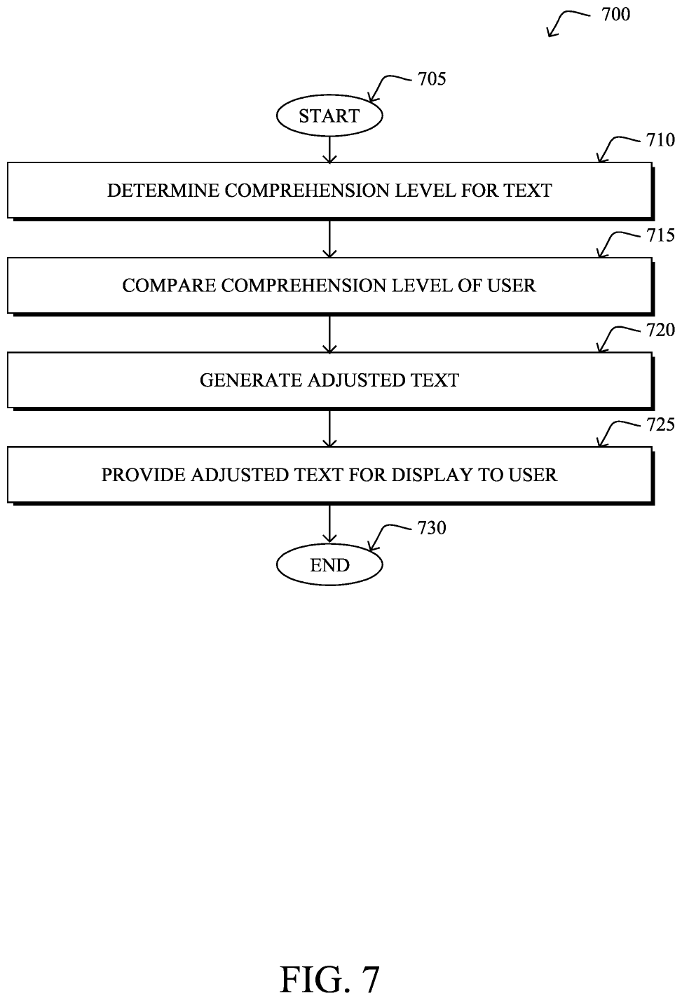

FIG. 7 illustrates an example simplified procedure (e.g., a method) for providing adjusted text for display to a participant of an online conversation, in accordance with one or more embodiments described herein. For example, a non-generic, specifically configured device (e.g., device 200), may perform procedure 700 by executing stored instructions (e.g., comprehension level adjustment process 248). The procedure 700 may start at step 705, and continues to step 710, where, as described in greater detail above, the device may determine a comprehension level for a portion of text associated with an online conversation, based in part on a topic of the portion of text. In some embodiments, the online conversation may be text-based. In other embodiments, the portion of text may be converted from audio or video of an online conference. The device may use any number of different scoring mechanisms, to determine the comprehension level for the portion of text such as a Flesch-Kincaid grade level, a Coleman-Liau index, a Dale-Chall readability formula, a Gunning fog index, combinations thereof, or the like.

At step 715, as detailed above, the device may make a comparison between the comprehension level for the portion of text with a comprehension level of a participant of the online conversation. In some embodiments, the device may determine the comprehension level of the participant based in part on the topic. In further embodiments, the device may determine their comprehension level based further in part on a user role or profile associated with the participant (e.g., data indicative of their education, expertise, demographics, etc.). In yet another embodiment, the device may make the comparison based in part by selecting a readability test to apply to the portion of text, based on one or more characteristics of that text (e.g., whether it is a single word, full sentence, etc.). In another embodiment, the device may compute the comprehension level of the participant by scoring text previously written by the participant, such as prior text of the online conversation, previous conversations, emails, etc.

At step 720, the device may generate adjusted text based on the portion of text, as described in greater detail above. In various embodiments, the device may do so such that the adjusted text has a comprehension level that is equal to, or lower, than that of the participant. For instance, the device may add text to the original portion of text, to provide context to the participant (e.g., by providing a definition, spelling out an acronym, etc.), replacing text (e.g., by replacing a word or phrase with an easier to understand word or phrase), changing text, or the like.

At step 725, as detailed above, the device may provide the adjusted text for display to the participant. In some embodiments, the device may also include an indication in the adjusted text that indicates whether the adjusted text replaces text in the portion of text, changes text in the portion of text, or adds text to the portion of text. In yet another embodiment, the device may generate a transcript of the online conversation that includes the adjusted text. In an additional embodiment, the device may report the comparison between the comprehension level for the portion of text with the comprehension level of a participant of the online conversation. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for an online conversation to be more inclusive of participants, by adjusting the conversation to a level that is more understandable by a given participant. In some aspects, the determination of reading and comprehension levels of users can be based upon historical documentation and correspondence. In another aspect, text, audio, and/or video samples can be used to drive this analysis. In further aspects, the system is able to adapt dynamically in the case of multi-speaker conversations. In addition, a curated, per-user topic and keyword comprehension translation experience can be provided in multi-participant scenarios. Historical comprehension data can also be used, in some instances, to drive the effectiveness of group makeups and aid in the creation of well-balanced teams.

While there have been shown and described illustrative embodiments that provide for context-aware conversation comprehension equivalency analysis and real time text enrichment feedback for enterprise collaboration, it is to be understood that various other adaptations and modifications may be made within the spirit and scope of the embodiments herein. For example, while certain embodiments are described herein with respect to using certain models for purposes of determining comprehension levels, the models are not limited as such and may be used for other analyses, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
determining, by a device, a comprehension level for a portion of text associated with an online conversation, based in part on a topic of the portion of text;
making, by the device, a comparison between the comprehension level for the portion of text with a comprehension level of a participant of the online conversation;
generating, by the device, adjusted text based on the portion of text, wherein the adjusted text has a comprehension level that is equal to or lower than that of the participant; and
providing, by the device, the adjusted text for display to the participant.

2. The method as in claim 1, further comprising:
determining, by the device, the comprehension level of the participant of the online conversation based in part on the topic.

3. The method as in claim 2, wherein the device determines the comprehension level of the participant of the online conversation based further in part on a user role or profile associated with the participant.

4. The method as in claim 1, wherein the portion of text is converted from audio or video of a video conference.

5. The method as in claim 1, wherein providing the adjusted text for display to the participant comprises:
including an indication in the adjusted text that indicates whether the adjusted text replaces text in the portion of text, changes text in the portion of text, or adds text to the portion of text.

6. The method as in claim 1, further comprising:
generating a transcript of the online conversation that includes the adjusted text.

7. The method as in claim 1, wherein the device provides the adjusted text for display to the participant, based in part on the participant setting an opt-in parameter to view the adjusted text.

8. The method as in claim 1, wherein making the comparison between the comprehension level for the portion of text with the comprehension level of the participant of the online conversation comprises:
selecting a readability test to apply to the portion of text, based one or more characteristics of the portion of text.

9. The method as in claim 1, further comprising:
computing the comprehension level of the participant by scoring text previously written by the participant.

10. The method as in claim 1, further comprising:
reporting, to a display, the comparison between the comprehension level for the portion of text with the comprehension level of a participant of the online conversation.

11. An apparatus, comprising:
one or more network interfaces;
a processor coupled to the one or more network interfaces and configured to execute one or more processes; and
a memory configured to store a process that is executable by the processor, the process when executed configured to:
determine a comprehension level for a portion of text associated with an online conversation, based in part on a topic of the portion of text;
make a comparison between the comprehension level for the portion of text with a comprehension level of a participant of the online conversation;
generate adjusted text based on the portion of text, wherein the adjusted text has a comprehension level that is equal to or lower than that of the participant; and
provide the adjusted text for display to the participant.

12. The apparatus as in claim 11, wherein the process when executed is further configured to:
determine the comprehension level of the participant of the online conversation based in part on the topic.

13. The apparatus as in claim 12, wherein the apparatus determines the comprehension level of the participant of the online conversation based further in part on a user role or profile associated with the participant.

14. The apparatus as in claim 11, wherein the portion of text is converted from audio of a video conference.

15. The apparatus as in claim 11, wherein the apparatus provides the adjusted text for display to the participant by:
including an indication in the adjusted text that indicates whether the adjusted text replaces text in the portion of text, changes text in the portion of text, or adds text to the portion of text.

16. The apparatus as in claim 11, wherein the process when executed is further configured to:
generate a transcript of the online conversation that includes the adjusted text.

17. The apparatus as in claim 11, wherein the apparatus provides the adjusted text for display to the participant, based in part on the participant setting an opt-in parameter to view the adjusted text.

18. The apparatus as in claim 11, wherein the apparatus makes the comparison between the comprehension level for the portion of text with the comprehension level of the participant of the online conversation by:
selecting a readability test to apply to the portion of text, based one or more characteristics of the portion of text.

19. The apparatus as in claim 11, wherein the process when executed is further configured to:
compute the comprehension level of the participant by scoring text previously written by the participant.

20. A tangible, non-transitory, computer-readable medium storing program instructions that cause a device to execute a process comprising:
determining, by the device, a comprehension level for a portion of text associated with an online conversation, based in part on a topic of the portion of text;
making, by the device, a comparison between the comprehension level for the portion of text with a comprehension level of a participant of the online conversation;
generating, by the device, adjusted text based on the portion of text, wherein the adjusted text has a comprehension level that is equal to or lower than that of the participant; and
providing, by the device, the adjusted text for display to the participant.
